(19) United States
(12) Patent Application Publication
(10) Pub. No.: US 2008/0162953 A1
(43) Pub. Date: Jul. 3, 2008

(54) Wi-Fi power saving method

(75) Inventor: Hsieh Kuang Hsun, Taipei City (TW)

Correspondence Address: BIRCH STEWART KOLASCH & BIRCH, PO BOX 747, FALLS CHURCH, VA, 22040-0747, US

(73) Assignee: Accton Technology Corporation

(21) Appl. No.: 11/648,830

(22) Filed: Jan. 3, 2007

(51) Int. Cl. G06F 1/00

(52) U.S. Cl. 713/300

(57) ABSTRACT

The present invention discloses that a power saving method for Wi-Fi (wireless local area network; Wireless Fidelity) module comprising the following steps. An associating step is performed with at least one of a full speed mode and a deep sleep mode controlled by a power management system. A network connecting step is performed with a power saving mode controlled by the power management system when completed the associating step. An operating step is performed with at least one of the full speed mode and the power saving mode controlled by the power management system when completed the network connecting step. An authenticating step is performed with at least one of the full speed mode, the power saving mode and the deep sleep mode controlled by the power management system when completed the operating step.

### FIELD OF THE INVENTION

The present invention is related to a method of power saving, and more particularly is related to a method of Wi-Fi (wireless local area network; Wireless Fidelity) power saving.

### BACKGROUND OF THE INVENTION

The main significant problem of the portable device is the power consuming. Without the support of the electricity, all functionalities of the portable device will become useless. Traditionally, the manufacturer developed large capacity battery in order to provide longer working hours for the portable device. However the specification of the portable device is not always unchanged, the new functionalities will be added into it. Usually, the newer functionality will require more power supply, on the other words the working hours of the portable device are trend to be shortened. But with the consideration of the portability of the portable device, the enormous batteries will cut it down due to their heavy weight. It is obvious that this solution of the present problems is not quite acceptable.

Besides, traditional the power saving procedure of electric equipment is not designed in a modular way, and the different electric equipment which is with similar functionalities usually will have totally dissimilar power saving procedures. It is not an economic procedure in designing electronic equipment, especially when other parts of the electronic equipment are designed in a modular way. The separated design procedures cost too many human resources and waste too much time, and it also extremely inefficient. In accordance with previous drawbacks, it is urgent to have a method for modular power saving method.

### SUMMARY OF THE INVENTION

The wireless network connection generally recites in a well-known four-step process, which comprises an associating step, a network connecting step, an operating step and an authenticating step. The detailed steps of the aforementioned four-step process can be found in many documents, such as IEEE papers. Because this four-step process is not the main idea of the present invention, we will not descript this four-step process in detailed in order not to obscure the present invention.

According to one aspect of the present invention, the present invention discloses that a power saving method for Wi-Fi (wireless local area network; Wireless Fidelity) module comprising the following steps. An associating step is performed with at least one of a full speed mode and a deep sleep mode controlled by a power management system. A network connecting step is performed with a power saving mode controlled by the power management system when completed the associating step. An operating step is performed with at least one of the full speed mode and the power saving mode controlled by the power management system when completed the network connecting step. An authenticating step is performed with at least one of the full speed mode, the power saving mode and the deep sleep mode controlled by the power management system when completed the operating step.

According to another aspect of the present invention, the present invention further discloses that the power management system is designed for Wi-Fi module. Besides, the power saving modules are all designed to follow certain rules, then the efforts of adding new module to the existed product can be reduced significantly. In addition, the wireless module of the present invention can be a wireless client module and a wireless server module.

Moreover, according to another aspect of the present invention, the power saving method further comprises choosing at least one of an AP (Access Point) mode and an Ad Hoc mode in accordance with a history record by the power management system in the associating step.

The full speed mode is transited to the deep sleep mode by the power management system when Wi-Fi module is timeout in the associating step. The deep sleep mode is transited to the full speed mode by the power management system when Wi-Fi module is sending a re-associating request in the associating step.

The network connecting step with the power saving mode is transferred to the operating step when Wi-Fi module is successfully connected in the network connecting step. The network connecting step with the power saving mode is feedback to the associating step when Wi-Fi module is timeout in the network connecting step. The network connecting step with the power saving mode is feedback to the associating step when Wi-Fi module is lost associating in the network connecting step. The network connecting step is feedback to the associating step when Wi-Fi module is requested an associating in the network connecting step.

The full speed mode is transited to the power saving mode by the power management system when Wi-Fi module is sending a low speed request in the operating step. The full speed mode is transited to the power saving mode by the power management system when Wi-Fi module is sending a host deep sleep request in the operating step. Wi-Fi driver of the Wi-Fi module is configured to wake up the host in the operating step. The power saving mode is transited to the full speed mode by the power management system when Wi-Fi module is sending a full speed request in the operating step.

The full speed mode is transited to the power saving mode by the power management system when Wi-Fi module is timeout in the authenticating step. The power saving mode is transited to the full speed mode by the power management system when Wi-Fi module is sending a full speed request in the authenticating step. The power saving mode is transited to the deep sleep mode by the power management system when Wi-Fi module is timeout at the power saving mode in the authenticating step.

The authenticating step is feedback to the operation step when Wi-Fi module is authenticated at the full speed mode in the authenticating step. The operating step is proceeded to the authenticating step when Wi-Fi module is sending an associating request in the operating step. The operating step is feedback to the network connecting step when Wi-Fi module is sending a connection lost in the operating step. The operating step is feedback to the associating step when Wi-Fi module is sending at least one of an associating request and an associating lost in the operating step. The authenticating step is feedback to the associating step when Wi-Fi module is sending an associating request in the authenticating step.

### BRIEF DESCRIPTION OF THE DRAWINGS

FIG. 1 is a flow chart, which illustrates a power saving method of the present invention.

FIG. 2 is a flow chart, which illustrates the power saving method of the FIG. 1 in detailed.

### DETAILED DESCRIPTION OF THE PREFERRED EMBODIMENT

The present invention is described with preferred embodiments and accompanying drawings. It should be appreciated that all the embodiments are merely used for illustration. Although the present invention has been described in term of a preferred embodiment, the invention is not limited to this embodiment. It will be understood, however, to one skilled in the art, that the present invention may be practiced without some or all of these specific details. In other instances, well known process operations have not been described in detail in order not to unnecessary obscure the present invention.

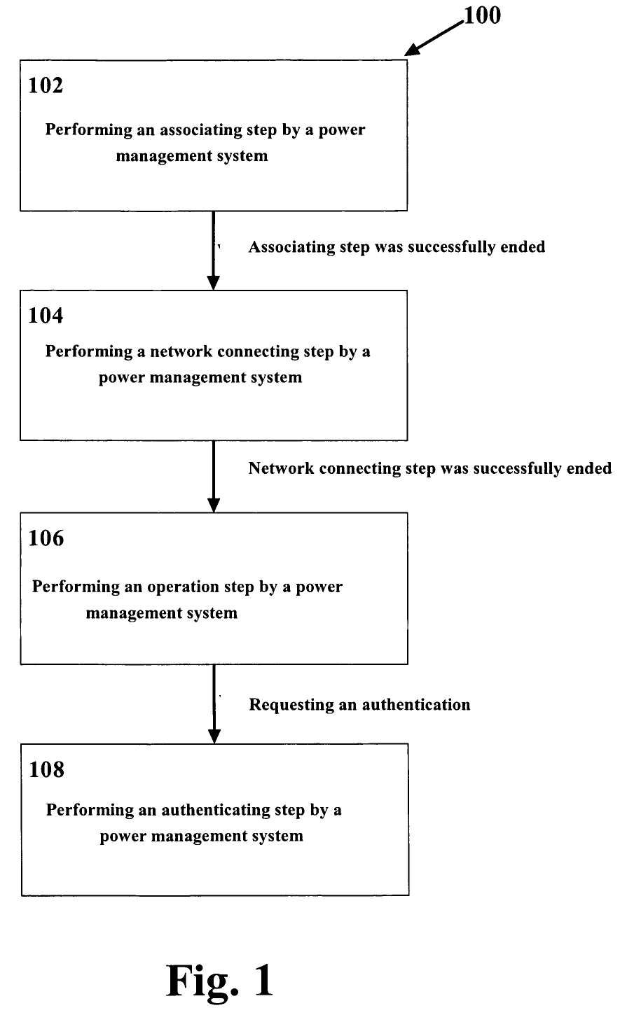

Referring to the FIG. 1 is a flow chart illustrating a power saving method 100 of the present invention. The power saving method 100 starts at the step 102, performing an associating step with at least one of a full speed mode and a deep sleep mode controlled by a power management system, and the detailed description of the associating process will be recited in the latter paragraph. For example, the power management system is applied to a Wi-Fi (wireless local area network; Wireless Fidelity) module. After the associating step, such as Wi-Fi associating step, is successfully ended, then the method steps will go to the step 104 to perform a network connecting step with a power saving mode controlled by the power management system when completed the associating step, and the detailed description of the connecting process will be recited in the latter paragraph. After the network connecting step is successfully ended, then the next step in the step 106 is to perform an operation step with at least one of the full speed mode and the power saving mode controlled by the power management system when completed the network connecting step, similarly, the detailed description of the operating process will be recited in the latter paragraph. When the Wi-Fi module requests a Wi-Fi authentication, please refer to step 108, the system perform an authenticating step with at least one of the full speed mode, the power saving mode and the deep sleep mode controlled by the power management system when completed the operating step.

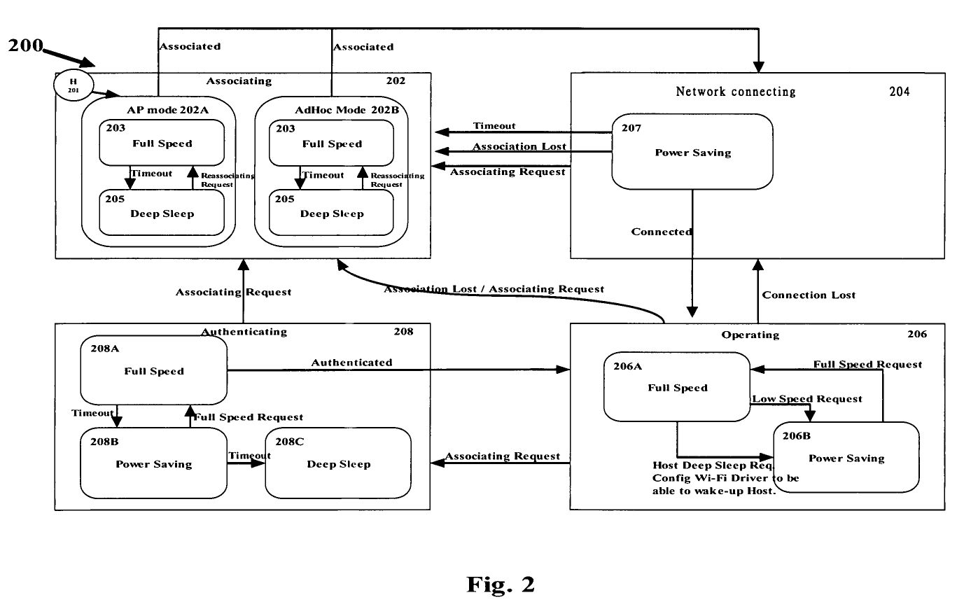

Referring to the FIG. 2, it shows a flow chart illustrating the power saving method 100, which is the detailed diagram according to FIG. 1. As you can see, the detailed power saving method 200 includes four general steps of the Wi-Fi connection, the associating step 202, the network connecting step 204, the operating step 206 and the authenticating step 208. Each of the steps needs different power saving method to adapt their specified characters. The whole Wi-Fi connection process is initiated at the associating step 202. Within the associating step 202, the power management system checks the connection mode of current connection that typically includes the AP mode 202A and the Ad Hoc mode 202B.

A mobile ad-hoc network (MANET) is a self-configuring network of mobile routers (and associated hosts) connected by wireless links—the union of which form an arbitrary topology. The routers are free to move randomly and organize themselves arbitrarily; thus, the network's wireless topology may change rapidly and unpredictably. Such a network may operate in a standalone fashion, or may be connected to the larger Internet.

The power management system consults the history record 201 (labeled as H in the FIG. 2) which is saving the user's selected mode in record data. The AP mode 202A and the Ad Hoc mode 202B are both implemented in the connecting process, which comprises two power consuming modes, i.e. the full speed mode and the deep sleep mode. The power consuming mode of the present invention is predetermined in three different types including a full speed mode, a power saving mode and a deep sleep mode. The detailed definition of each mode should be further configured in order to reach distinct efficiency of different products.

In the present invention, power consuming mode comprises a full speed mode, a deep sleep mode and power saving mode. The connecting process of the AP mode 202A and the Ad Hoc mode 202B include the full speed mode 203 and the deep sleep mode 205. When the power management system detects a timeout situation at the full speed mode 203 of the AP mode 202A, the power management system will transit the power consuming mode to the deep sleep mode 205 in order to extend the battery working hours. When the power management system detects a re-associating request at the deep sleep mode 205 of the AP mode 202A, then the power management system will transit the power consuming mode to the full speed mode 203 in order to achieve the maximum performance. The first two-phase power saving process of the Ad Hoc mode 202B is also working as the same manner. In the preferred embodiment, the “timeout” means that the performing process is over a pre-determined time.

At the network connecting step 204, the power consuming mode only includes the power saving mode 207. Because the power consume of the network connecting step 204 is relatively low, it only needs less power than any other step. After the connection is successfully established, the process runs to the operating step 206. Moreover, the network connecting step 204 with the power saving mode 207 is feedback to the associating step 202 when Wi-Fi module is timeout in the network connecting step 204. And the network connecting step 204 with the power saving mode 207 is feedback to the associating step 202 when Wi-Fi module is lost associating in the network connecting step 204. Besides, the network connecting step 204 is feedback to the associating step 202 when Wi-Fi module is requested an associating in the network connecting step 204.

At the operating step 206, the power management system executes two-modes power consuming mode which includes the full speed mode 206A and the power saving mode 206B. These two modes are equally functioned as previous the power saving mode 207 and the full speed mode 203. When the power management system detects a low speed request/host deep sleep request at the full speed mode 206A of the operating step 206, the power management system will transit power consuming mode to the power saving mode 206B in order to extend the battery working hours. Wi-Fi driver of the Wi-Fi module is configured to wake up the host in the operating step 206. Besides, when the power management system detects a full speed request at the power saving mode 206B of the operating step 206, the power management system will transit the power consuming mode to the full speed mode 206A according to the detection in order to achieve the maximum performance.

In accordance with some setting of the wireless network environment, it needs additional authentication. Therefore, at the authenticating step 208, the power management system executes three-modes power saving process, and the three-modes power consumong mode includes the full speed mode 208A, the power saving mode 208B and the deep sleep mode 208C. These three modes are equally functioned as previous all power consuming modes. When the power management system detects a timeout at the full speed mode 208A of the authenticating step 208, and the power management system will transit the power consuming mode to the power saving mode 208B in order to extend the battery working hours. Besides, when the power management system detect a full speed request at the power saving mode 208B of the authenticating step 208, and the power management system will transit the power consuming mode to the full speed mode 208A in order to achieve the maximum performance. Moreover, when the power management system detects another timeout at the power saving mode 208B of the authenticating step 208, and the power management system will transit the power consuming mode to the deep sleep mode 208C in order to extend the battery working hours.

Moreover, the authenticating step 208 is feedback to the operation step 206 when Wi-Fi module is authenticated at the full speed mode 208A in the authenticating step 208. The operating step 206 is proceeded to the authenticating step 208 when Wi-Fi module is sending an associating request in the operating step 206. Besides, the operating step 206 is feedback to the network connecting step 204 when Wi-Fi module is sending a connection lost in the operating step 206. The operating step 206 is feedback to the associating step 202 when Wi-Fi module is sending at least one of an associating request and an associating lost in the operating step 206. Furthermore, the authenticating step 208 is feedback to the associating step 202 when Wi-Fi module is sending an associating request in the authenticating step 208.

Furthermore, all the transitions are based on experiments of wireless connection in order to fine tune the best selection of power consuming modes. Moreover, the determination between the full speed and the low speed can be done by judging the total throughput of the current wireless connection or by judging the number of the packets within the current wireless connection.

Other embodiments of the invention will be apparent to those skilled in the art from consideration of the specification and practice of the invention. The word “comprising” and forms of the word “comprising” as used in the description and in the claims are not meant to exclude variants or additions to the invention. Furthermore, certain terminology has been used for the purposes of descriptive clarity, and not to limit the present invention. The embodiments and preferred features described above should be considered exemplary, with the invention being defined by the appended claims.

We claim:

1. A power saving method, comprising:
performing an associating step with at least one of a full speed mode and a deep sleep mode controlled by a power management system;
performing a network connecting step with a power saving mode controlled by said power management system when completed said associating step;
performing an operation step with at least one of said full speed mode and said power saving mode controlled by said power management system when completed said network connecting step; and
performing an authenticating step with at least one of said full speed mode, said power saving mode and said deep sleep mode controlled by said power management system when completed said operating step.

2. The power saving method of claim 1, wherein said power management system is designed for Wi-Fi module.

3. The power saving method of claim 2, wherein said Wi-Fi module comprises a wireless client module and a wireless server module.

4. The power saving method of claim 2 further comprising:
choosing at least one of an AP (Access Point) mode and an Ad Hoc mode in accordance with a history record by said power management system in said associating step.

5. The power saving method of claim 4, wherein said full speed mode is transited to said deep sleep mode by said power management system when said Wi-Fi module is timeout.

6. The power saving method of claim 4, wherein said deep sleep mode is transited to said full speed mode by said power management system when said Wi-Fi module is sending a re-associating request.

7. The power saving method of claim 4, wherein said network connecting step with said power saving mode is feedback to said operating step when said Wi-Fi module is successfully connected in said network connecting step.

8. The power saving method of claim 4, wherein said network connecting step with said power saving mode is feedback to said associating step when said Wi-Fi module is timeout in said network connecting step.

9. The power saving method of claim 4, wherein said network connecting step with said power saving mode is feedback to said associating step when said Wi-Fi module is lost associating in said network connecting step.

10. The power saving method of claim 4, wherein said network connecting step is feedback to said associating step when said Wi-Fi module is requested an associating in said network connecting step.

11. The power saving method of claim 4, wherein said full speed mode is transited to said power saving mode by said power management system when said Wi-Fi module is sending a low speed request in said operating step.

12. The power saving method of claim 4, wherein said full speed mode is transited to said power saving mode by said power management system when said Wi-Fi module is sending a host deep sleep request in said operating step.

13. The power saving method of claim 12, wherein Wi-Fi driver of said Wi-Fi module is configured to wake up said host in said operating step.

14. The power saving method of claim 4, wherein said power saving mode is transited to said full speed mode by said power management system when said Wi-Fi module is sending a full speed request in said operating step.

15. The power saving method of claim 4, wherein said full speed mode is transited to said power saving mode by said power management system when said Wi-Fi module is timeout in said authenticating step.

16. The power saving method of claim 4, wherein said power saving mode is transited to said full speed mode by said power management system when said Wi-Fi module is sending a full speed request in said authenticating step.

17. The power saving method of claim 4, wherein said power saving mode is transited to said deep sleep mode by said power management system when said Wi-Fi module is timeout at said power saving mode in said authenticating step.

18. The power saving method of claim 4, wherein said authenticating step is feedback to said operation step when said Wi-Fi module is authenticated at said full speed mode in said authenticating step.

19. The power saving method of claim 4, wherein said operating step is feedback to said authenticating step when said Wi-Fi module is sending an associating request in said operating step.

20. The power saving method of claim 4, wherein said operating step is feedback to said network connecting step when said Wi-Fi module is sending a connection lost in said operating step.

21. The power saving method of claim 4, wherein said operating step is feedback to said associating step when said Wi-Fi module is sending at least one of an associating request and an associating lost in said operating step.

22. The power saving method of claim 4, wherein said authenticating step is feedback to said associating step when said Wi-Fi module is sending an associating request in said authenticating step.
